(19) United States
(12) Patent Application Publication
(10) Pub. No.: US 2005/0097805 A1
(43) Pub. Date: May 12, 2005

(54) Guide ring for a fishing rod

(76) Inventor: Tsung-Seng Lee, Tainan City (TW)

Correspondence Address: BIRCH STEWART KOLASCH & BIRCH, PO BOX 747, FALLS CHURCH, VA, 22040-0747, US

(21) Appl. No.: 10/702,477

(22) Filed: Nov. 7, 2003

(51) Int. Cl. A01K 87/04

(52) U.S. Cl. 43/24

(57) ABSTRACT

A guide ring for a fishing rod includes a fixing frame. The fixing frame includes a ring, a front and rear conical inclined portions and a front and rear fixing legs. The front and rear conical inclined portions are downward and slightly outward expanded from two sides of the ring and then respectively forward and backward longitudinal expanded to the fishing rod. The front conical inclined portion is corresponding to the rear conical inclined portion in opposite direction. The front and rear fixing legs are respectively formed at the end of the front and rear conical inclined portions and aligned with each other.

### FIELD OF THE INVENTION

The present invention relates to a guide ring for a fishing rod, and more particularly to a guide ring for a fishing rod including a fixing frame which is designed to be flexible so as to decrease the fixing frame to affect the deflection of the fishing rod when the fishing rod is flung.

### BACKGROUND OF THE INVENTION

Conventional guide ring for a fishing rod, showed in FIG. 1, has a conical arc which is downward expanded from two sides of the guide ring and then is longitudinal expanded to the fishing rod. A pair of symmetrical flat fixing legs and an arrow-shaped fixing leg which is corresponding to the flat fixing legs are formed at the end of the conical arc. The flat fixing legs and the arrow-shaped fixing leg are respectively fixed at the suitable position of the fishing rod by entwining fishing lines around the fishing rod. There are some disadvantages of conventional guide ring for the fishing rod as follows:

1. When the fishing rod is flung or pulled, the fishing line may be entwined because the fishing rod is waved to loose the fishing line and simultaneously the fishing line is not recovered the fishing line on time.

2. The stress generated by the fishing rod is concentrated at the flat fixing leg and the arrow-shaped fixing leg. When the fishing rod is flung, the fishing rod may be cracked because the flat fixing legs and the arrow-shaped fixing leg of the guide ring fix the fishing rod and further decrease the deflection of the fishing rod, showed in FIG. 2. Accordingly, there exists a need for a guide ring for a fishing rod to solve the above-mentioned problems and disadvantages.

### SUMMARY OF THE INVENTION

It is an object of the present invention to provide a guide ring for a fishing rod including a fixing frame which can avoid the fishing rod cracking and decrease the cost of material and the manufacturing time.

In order to achieve the foregoing objects, the present invention provides a guide ring for a fishing rod including a fixing frame. The fixing frame includes a ring, a front and rear conical inclined portions and a front and rear fixing legs. The front and rear conical inclined portions are downward and slightly outward expanded from two sides of the ring and then respectively forward and backward longitudinal expanded to the fishing rod. The front conical inclined portion is corresponding to the rear conical inclined portion in opposite direction. The front and rear fixing legs are respectively formed at the end of the front and rear conical inclined portions and aligned with each other.

The fixing frame according to the present invention is designed to be flexible so as to decrease the fixing frame to affect the deflection of the fishing rod, avoid the fishing rod cracking when flung, and decrease the cost of material and the manufacturing time.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a guide ring for a fishing rod in the prior art.

FIG. 2 is a perspective view showing an embodiment of a guide ring for a fishing rod in the prior art.

FIG. 3 is a perspective view of a guide ring for a fishing rod according to the first embodiment of the present invention.

FIG. 4 is a front elevational view of a guide ring for a fishing rod according to the first embodiment of the present invention.

FIG. 5 is a top plan view of a guide ring for a fishing rod according to the first embodiment of the present invention.

FIG. 6 is a side elevational view of a guide ring for a fishing rod according to the first embodiment of the present invention.

FIG. 7 is a side elevational view showing a guide ring for a fishing rod forward and backward pulled by pulling force, according to the first embodiment of the present invention.

FIG. 8 is a perspective view showing an embodiment of a guide ring for a fishing rod according to the first embodiment of the present invention.

FIG. 9 is a perspective view of a guide ring for a fishing rod according to the second embodiment of the present invention.

FIG. 10 is a front elevational view of a guide ring for a fishing rod according to the second embodiment of the present invention.

FIG. 11 is a top plan view of a guide ring for a fishing rod according to the second embodiment of the present invention.

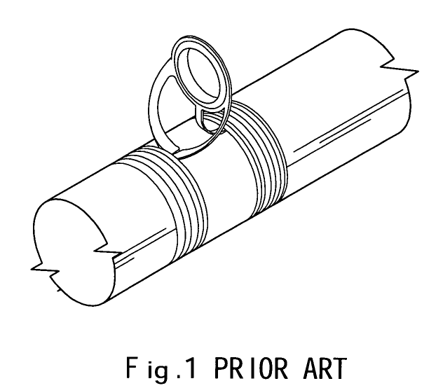

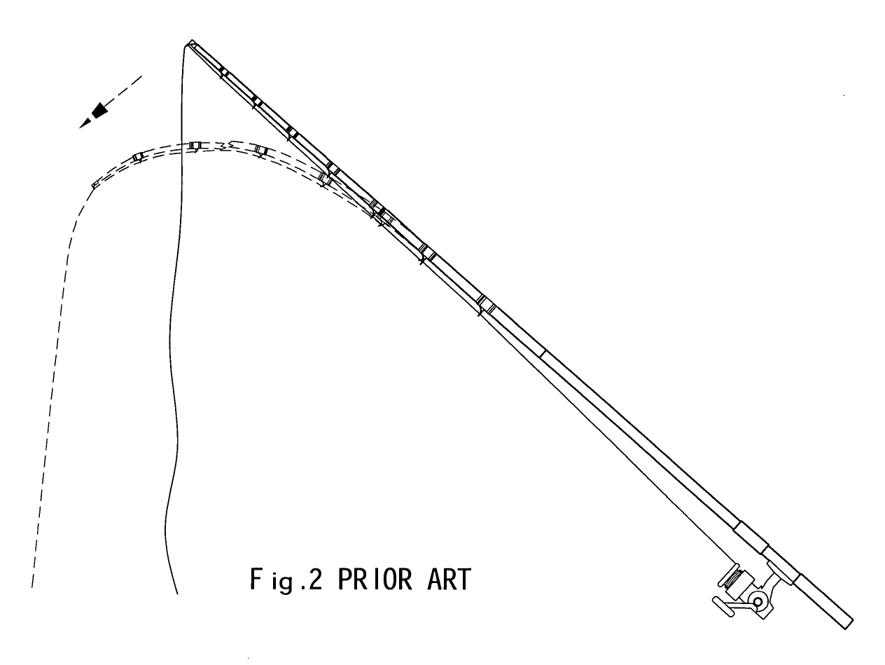

### DETAILED DESCRIPTION OF THE PREFERRED EMBODIMENTS

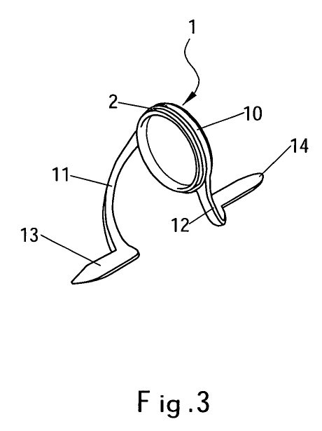

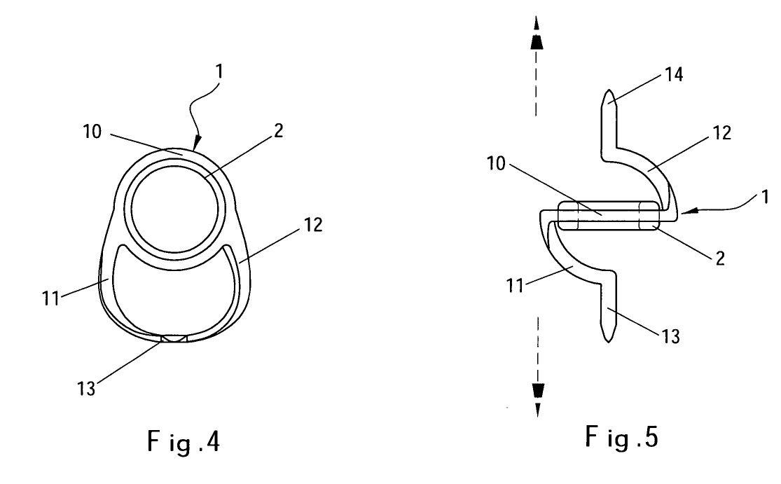

Referring to FIGS. 3 and 4, they depict a guide ring for a fishing rod according to the first embodiment of the present invention. The guide ring includes a fixing frame 1 and a ceramic ring 2. The fixing frame 1 includes a ring 10 and a front and rear conical inclined portions 11, 12 which are downward and slightly outward expanded from two sides of the ring 10 and then forward and backward longitudinal expanded to the fishing rod, respectively. The front conical inclined portion 11 is corresponding to the rear conical inclined portion 12 in opposite direction. A front and rear fixing legs 13, 14 are respectively formed at the end of the front and rear conical inclined portions 11, 12, and the rear fixing leg 14 is aligned with the front fixing leg 13, as shown in FIG. 5.

The ceramic ring 2 is made of ceramic material. The surface of the ceramic ring 2 is smooth and the hardness of the ceramic ring 2 is high such that the ceramic ring 2 can tolerate the fishing line fast passing through the inside thereof.

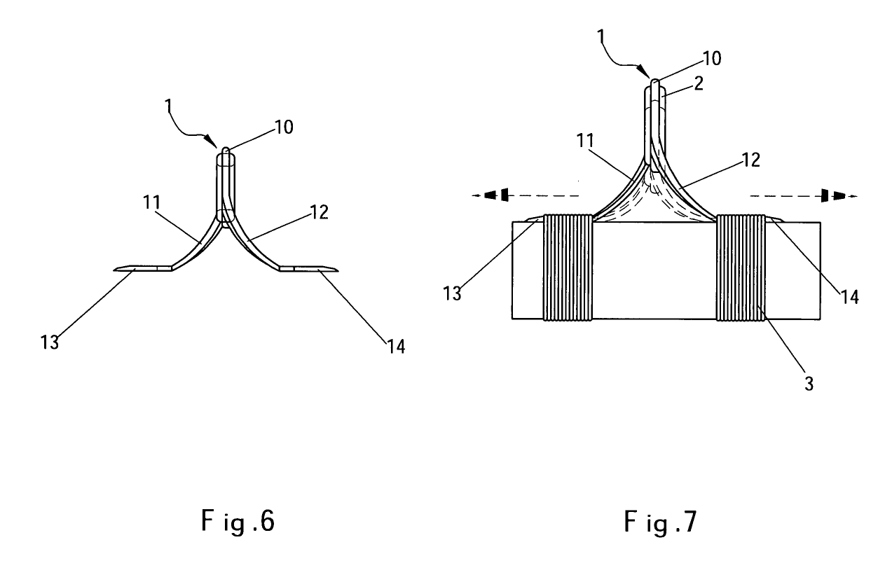

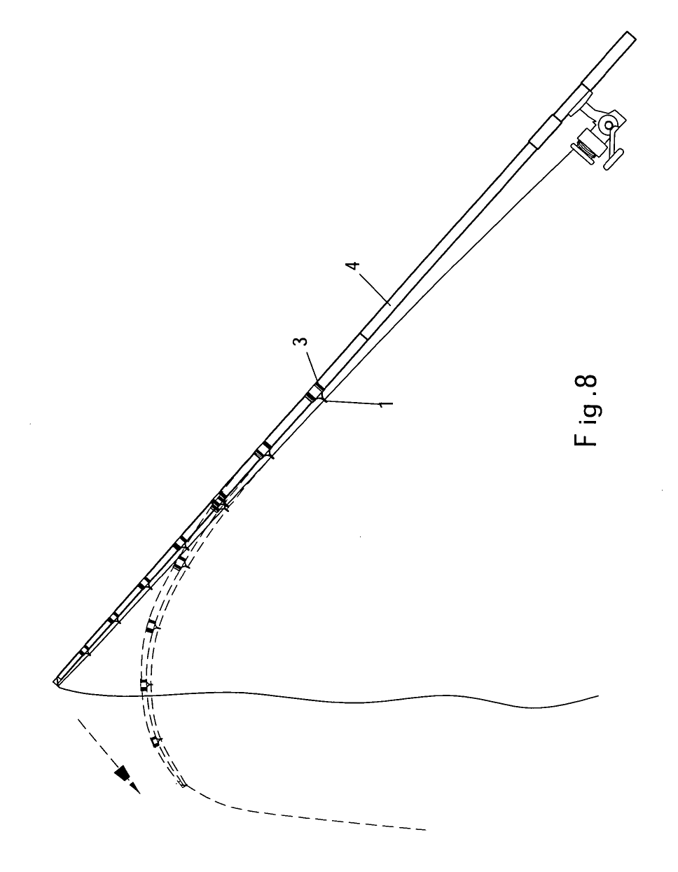

The above-mentioned front fixing leg 13 of the fixing frame 1 is formed by expanding the front conical inclined portion 11 from one side of the ring 10 and forward parallel to the fishing rod and the rear fixing leg 14 is formed by expanding the rear conical inclined portion 12 from the other side of the ring 10 and backward parallel to the fishing rod, as shown in FIG. 6.

As shown in FIG. 7, the front and rear fixing legs 13, 14 are respectively fixed at the suitable position of the fishing rod 4 by entwining fishing line 3 around the fishing rod 4. When the fishing rod 4 is flung by pulling force, the fishing rod 4 is curved and therefore the front and rear conical inclined portions 11, 12 of the fixing frame 1 are affected by the pulling force. Along the direction of the pulling force (the direction of arrow with broken line is shown in FIG. 7), the front and rear conical inclined portions 11, 12 are forward and backward pulled, respectively. The fixing frame 1 according to the present invention is designed to be flexible so as to decrease the fixing frame 1 to affect the deflection of the fishing rod 4.

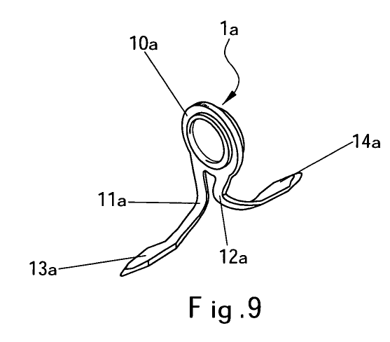

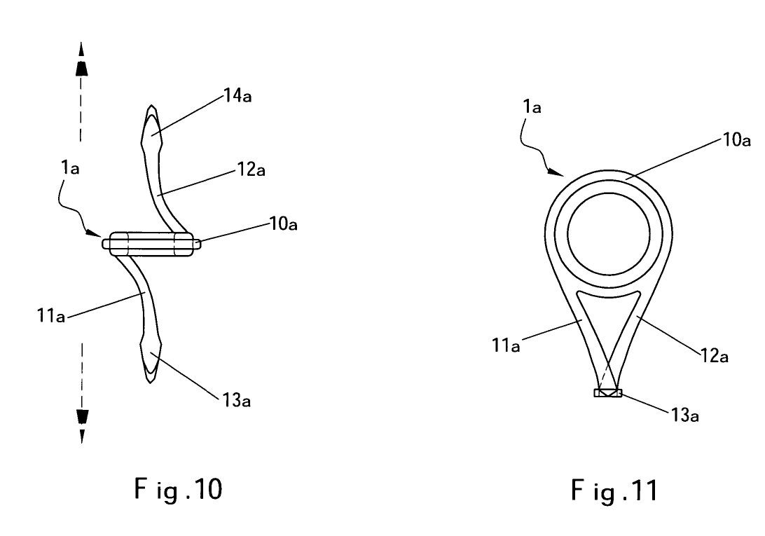

Referring to FIGS. 9, 10 and 11, they depict a guide ring for a fishing rod according to the second embodiment of the present invention. The guide ring for a fishing rod according to the second embodiment is similar to the guide ring for the fishing rod according to the first embodiment, and the identical elements are designated with the same reference numerals. The fixing frame 1a includes a ring 10a and a front and rear conical inclined portions 11a, 12a which are downward and inward expanded from the vicinity of bottom of the ring 10a, and then forward and backward longitudinal expanded to the fishing rod, respectively. A front and rear fixing legs 13a, 14a are respectively formed at the end of the front and rear conical inclined portions 11a, 12a, and the rear fixing leg 14a is aligned with the front fixing leg 13a. As described above, the fixing frame 1a according to the present invention is designed to be more flexible so as to decrease the front and rear fixing legs 13a, 14a of the fixing frame 1a to affect the deflection of the fishing rod 4.

Although the invention has been explained in relation to its preferred embodiment, it is not used to limit the invention. It is to be understood that many other possible modifications and variations can be made by those skilled in the art without departing from the spirit and scope of the invention as hereinafter claimed.

1. A guide ring for a fishing rod comprising:
a ceramic ring;
a fixing frame including:
a frame ring surrounding the ceramic ring;
front and rear conical inclined portions downward and slightly outward expanded from two sides of said frame ring and then respectively forward and backward longitudinal expanded to said fishing rod, said front conical inclined portion corresponding to said rear conical inclined portion in an opposite direction; and
front and rear fixing legs respectively formed at the ends of said front and rear conical inclined portion and aligned with each other.

2. A guide ring for a fishing rod comprising:
a ceramic ring;
a fixing frame including:
a frame ring surrounding the ceramic ring;
front and rear conical inclined portions downward and inward expanded from the vicinity of a bottom of said frame ring and then respectively forward and backward longitudinal expanded to said fishing rod; and
front and rear fixing legs respectively formed at the ends of said front and rear conical inclined portions and aligned with each other.

3. The guide ring for a fishing rod as recited in claim 1, wherein upper sections of the front and rear conical inclined portions are spaced transversely further from a centerline of the fishing rod than the ends of the front and rear conical inclined portions such that the front and rear conical inclined portions approach the centerline of the fishing rod.

4. The guide ring for a fishing rod as recited in claim 3, wherein the upper sections of the front and rear conical inclined portions extend from sides of the frame ring.

5. The guide ring for a fishing rod as recited in claim 4, wherein the front and rear conical inclined portions have a mirror image curvature when viewed in the longitudinal direction of the fishing rod.

6. The guide ring for a fishing rod as recited in claim 5, wherein the front and rear conical inclined portions are curved in both the longitudinal and transverse directions of the fishing rod.

7. The guide ring for a fishing rod as recited in claim 6, wherein the front leg extends perpendicularly from the front conical inclined portion and wherein the rear fixing leg extends perpendicularly from the rear conical inclined portion.

8. The guide ring for a fishing rod as recited in claim 1, wherein upper sections of the front and rear conical inclined portions extend from sides of the frame ring.

9. The guide ring for a fishing rod as recited in claim 8, wherein the front and rear conical inclined portions are curved in both the longitudinal and transverse directions of the fishing rod.

10. The guide ring for a fishing rod as recited in claim 1, wherein the front and rear conical inclined portions have a mirror image curvature when viewed in the longitudinal direction of the fishing rod.

11. The guide ring for a fishing rod as recited in claim 1, wherein the front and rear conical inclined portions are curved in both the longitudinal and transverse directions of the fishing rod.

12. The guide ring for a fishing rod as recited in claim 1, wherein the front leg extends perpendicularly from the front conical inclined portion and wherein the rear fixing leg extends perpendicularly from the rear conical inclined portion.

13. The guide ring for a fishing rod as recited in claim 2, wherein upper sections of the front and rear conical inclined portions are spaced transversely further from a centerline of the fishing rod than the ends of the front and rear conical inclined portions such that the front and rear conical inclined portions approach the centerline of the fishing rod.

14. The guide ring for a fishing rod as recited in claim 13, wherein the upper sections of the front and rear conical inclined portions extend from sides of the frame ring.

15. The guide ring for a fishing rod as recited in claim 14, wherein the front and rear conical inclined portions have a mirror image curvature when viewed in the longitudinal direction of the fishing rod.

16. The guide ring for a fishing rod as recited in claim 15, wherein the front and rear conical inclined portions are curved in both the longitudinal and transverse directions of the fishing rod.

17. The guide ring for a fishing rod as recited in claim 16, wherein the rear fixing leg extends from the rear conical inclined portion in a curve when viewed from a top of the guide ring.

18. The guide ring for a fishing rod as recited in claim 2, wherein the upper sections of the front and rear conical inclined portions extend from sides of the frame ring.

19. The guide ring for a fishing rod as recited in claim 2, wherein the front and rear conical inclined portions have a mirror image curvature when viewed in the longitudinal direction of the fishing rod.

20. The guide ring for a fishing rod as recited in claim 2, wherein the rear fixing leg extends from the rear conical inclined portion in a curve when viewed from a top of the guide ring.
